(19) United States
(12) Patent Application Publication
(10) Pub. No.: US 2015/0033137 A1
(43) Pub. Date: Jan. 29, 2015

(54) VIEWER WITH NAVIGATION BETWEEN OPTICAL NETWORK GRAPHICAL VIEWS

(71) Applicant: Infinera Corporation, Sunnyvale, CA (US)

(72) Inventors: Karthikeyan M. NAGARAJAN, Bangalore (IN); Yashpal Kumar, Bangalore (IN); Lam D. Hoang, San Jose, CA (US); Pydi Kasi Viswanadham, Bangalore (IN)

(21) Appl. No.: 14/514,876

(22) Filed: Oct. 15, 2014

Related U.S. Application Data
(63) Continuation-in-part of application No. 13/538,098, filed on Jun. 29, 2012.

(51) Int. Cl. H04L 12/24; G06F 3/0485

(52) U.S. Cl. CPC H04L 41/22; G06F 3/0485; H04B 10/07
USPC 715/736

(57) ABSTRACT

A device may receive optical network information associated with optical devices included in an optical network. The optical network information may include first optical network information and second optical network information. The second optical network information may include at least some information that is different from the first optical network information, and may relate to the first optical network information. The device may provide the first optical network information via a first section of a user interface. The device may detect an interaction with the first optical network information. The device may provide, based on detecting the interaction, the second optical network information via a second section of the user interface that is different from the first section, or may provide a display indicator that identifies the second optical network information provided via the second section of the user interface.

### RELATED APPLICATION

This application is a continuation-in-part (CIP) of U.S. patent application Ser. No. 13/538,098, filed on Jun. 29, 2012, the content of which is incorporated by reference herein in its entirety.

### BACKGROUND

In optical networks, signals may be transmitted at various wavelengths, with each wavelength corresponding to a transmission channel. Optical links may connect network nodes so that signals may be transmitted throughout the optical network. An optical route may use a series of network nodes and optical links to connect a source of an optical transmission with a destination for the optical transmission.

### SUMMARY

According to some possible implementations, a device may receive optical network information associated with optical devices included in an optical network. The optical network information may include first optical network information and second optical network information. The second optical network information may include at least some information that is different from the first optical network information, and may relate to the first optical network information. The device may provide the first optical network information via a first section of a user interface. The device may detect an interaction with the first optical network information. The device may provide, based on detecting the interaction, the second optical network information via a second section of the user interface that is different from the first section, or may provide a display indicator that identifies the second optical network information provided via the second section of the user interface.

According to some possible implementations, a computer-readable medium may store instructions that, when executed by a processor, cause the processor to receive optical network information associated with an optical network. The optical network information may include first optical network information and second optical network information. The first optical network information may include a first level of information, and the second optical network information may include a second level of information. The second level of information may be lower and may contain more details than the first level of information. The instructions may cause the processor to provide the first optical network information via a first section of a user interface. The instructions may cause the processor to detect an interaction with the first optical network information. The instructions may cause the processor to provide, based on detecting the interaction, the second optical network information via a second section of the user interface that is different from the first section, or to provide a display indicator that visually distinguishes the second optical network information within the second section of the user interface.

According to some possible implementations, a method may include receiving, by a device, optical network information associated with optical devices included in an optical network. The optical network information may include first optical network information and second optical network information. The second optical network information may include information associated with a lower layer of the optical network than the first optical network information, and may relate to the first optical network information. The method may include providing, by the device, the first optical network information for display via a first section of a user interface. The method may include detecting, by the device, an interaction associated with the first optical network information. The method may include providing, by the device and based on detecting the interaction, the second optical network information for display via a second section of the user interface that is different from the first section, or providing a display indicator identifying the second optical network information provided for display via the second section of the user interface.

### BRIEF DESCRIPTION OF DRAWINGS

FIGS. 1A and 1B are diagrams of an overview of an example implementation described herein;

FIG. 2A is a diagram of an example environment in which systems and/or methods, described herein, may be implemented;

FIG. 2B is a diagram of example devices of an optical network that may be monitored and/or configured according to implementations described herein;

FIG. 2C is a diagram of example super-channels that may be monitored and/or configured according to implementations described herein;

FIG. 3 is a diagram of example components of one or more devices and/or systems of FIG. 2A and/or FIG. 2B;

FIG. 4 is a flow chart of an example process for receiving and storing optical network information, and providing the optical network information via a user interface;

FIGS. 5A-5E are diagrams of an example implementation relating to the example process shown in FIG. 4;

FIG. 6 is a flow chart of an example process for providing user navigability of a user interface that displays optical network information; and

FIGS. 7A-7C are diagrams of an example implementation relating to the example process shown in FIG. 6.

### DETAILED DESCRIPTION

The following detailed description of example embodiments refers to the accompanying drawings. The same reference numbers in different drawings may identify the same or similar elements.

Administrators and/or users of an optical network may want to determine information associated with the optical network, such as diagnostic information that may be used to diagnose and/or correct problems associated with the optical network. Optical network information may include a wide variety of information, such as information associated with an optical link, an optical device, an optical component, an optical super-channel, an optical channel, or the like. Providing too much optical network information may confuse the user, and providing too little optical network information may hide problems, both of which may make it difficult to diagnose and correct problems with the optical network. Implementations described herein provide a user interface with different sections for viewing different types of optical network information, depending on a type of optical network information that the user wishes to monitor. Furthermore, implementations described herein provide input mechanisms for the user to easily navigate between the different sections of the user interface, to help the user find relevant optical network information.

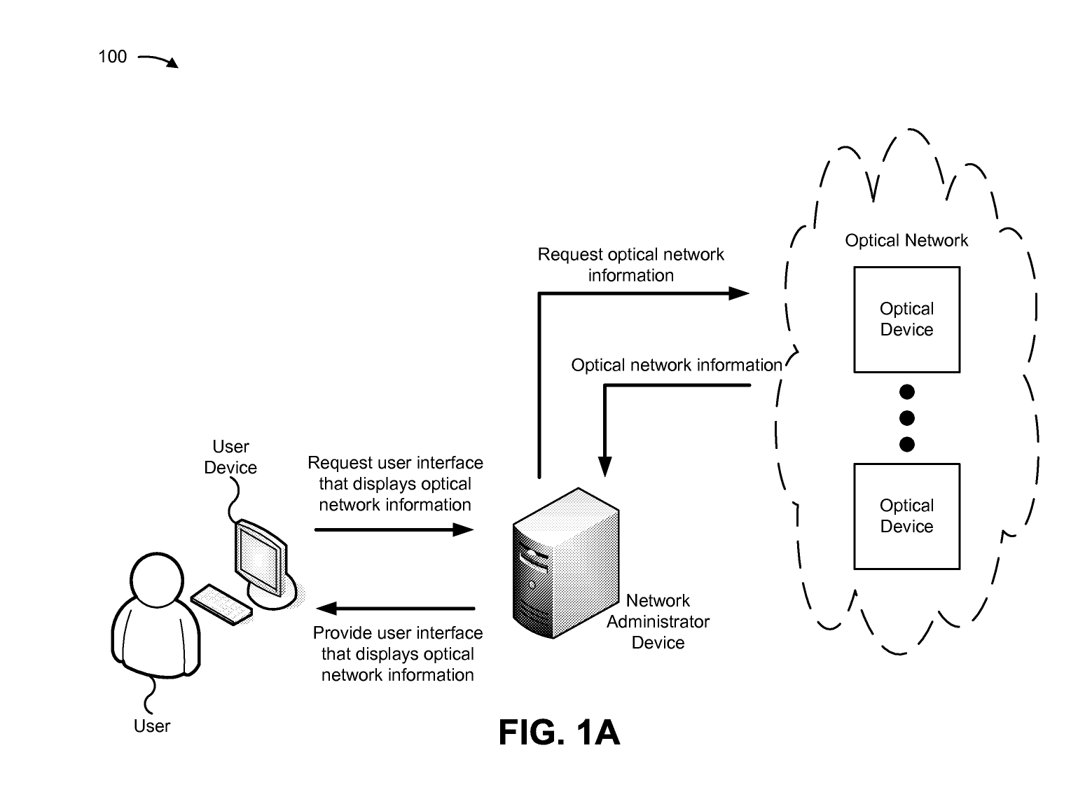

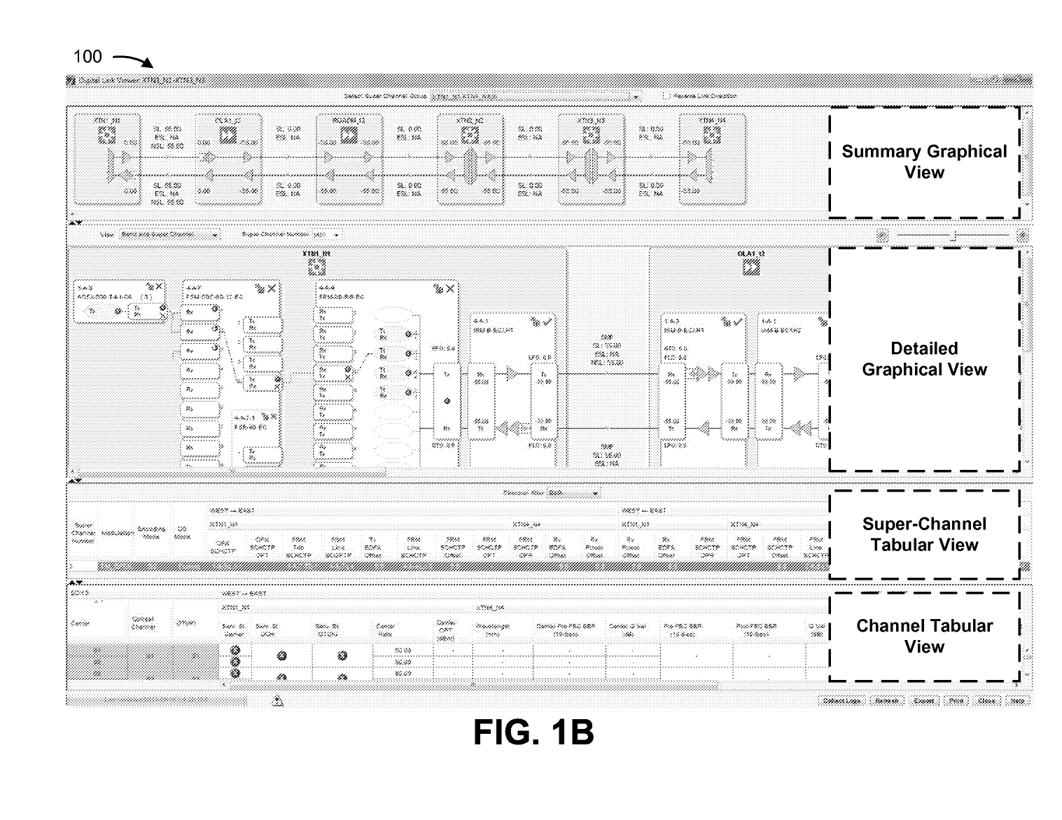

FIGS. 1A and 1B are diagrams of an overview of an example implementation 100 described herein. As shown in FIG. 1A, a user interacting with a user device (e.g., a desktop computer, a laptop computer, etc.) may request, from a network administrator device (e.g., a server, a network device, etc.), a user interface that displays optical network information. The network administrator device may request the optical network information from one or more optical devices in an optical network. The network administrator device may receive the requested optical network information from the optical devices (or may retrieve the requested optical network information from memory), and may provide the optical network information to the user device for display on the user interface.

As shown in FIG. 1B, the user device may provide the requested optical network information via the user interface. As further shown, the user device may provide different optical network information (e.g., different levels of detail with more or less information) via different sections of the user interface. For example, the user interface may include a summary view (e.g., a “Summary Graphical View”) that provides high-level summary information relating to one or more optical devices and/or optical links included in an optical route. The user interface may also include a detailed view (e.g., a “Detailed Graphical View”) that provides low-level detailed information relating to the optical device(s) and/or optical link(s), such as information relating to an optical component included in an optical device. The user may select a representation of a node or a link in the summary view to cause the user device to provide or highlight detailed information, associated with the selected node or link, in the detailed view. In this way, the user may drill-down to obtain desired optical network information, such as to diagnose a problem associated with the selected node or link.

As further shown in FIG. 1B, the user interface may include a super-channel view (e.g., a “Super-Channel Tabular View”) that provides super-channel information relating to one or more super-channels configured on an optical component, an optical device, and/or an optical link. The user may select a representation of a super-channel in the detailed view to cause the user device to provide or highlight super-channel information, associated with the selected super-channel, in the super-channel view. In this way, the user may drill-down to obtain desired optical network information, such as to diagnose a problem associated with the selected super-channel.

As further shown in FIG. 1B, the user interface may include a channel view (e.g., a “Channel Tabular View”) that provides channel information relating to one or more channels included in a super-channel. The user may select a representation of a channel in the super-channel view to cause the user device to provide or highlight channel information, associated with the selected channel, in the channel view. In this way, the user may drill-down to obtain desired optical network information, such as to diagnose a problem associated with the selected channel. By providing different user interface sections and navigation between the sections as described herein, the user device may permit a user to drill-down into optical network information to more easily and efficiently monitor an optical network and/or diagnose optical network problems.

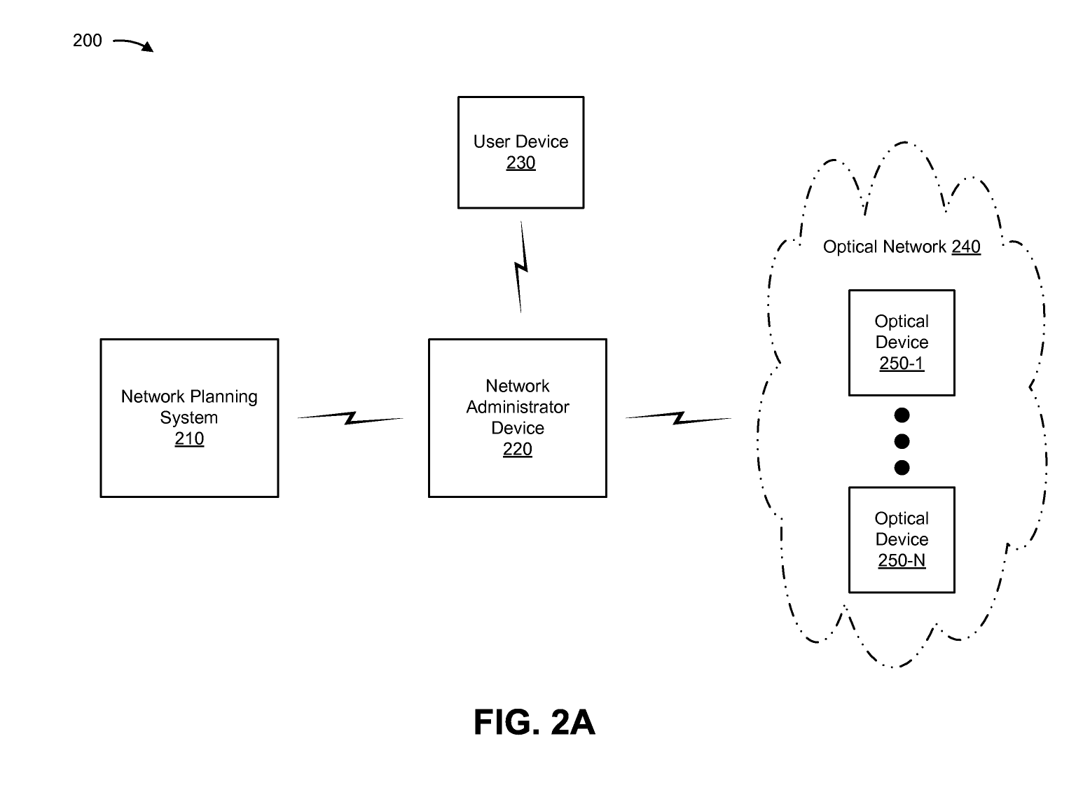

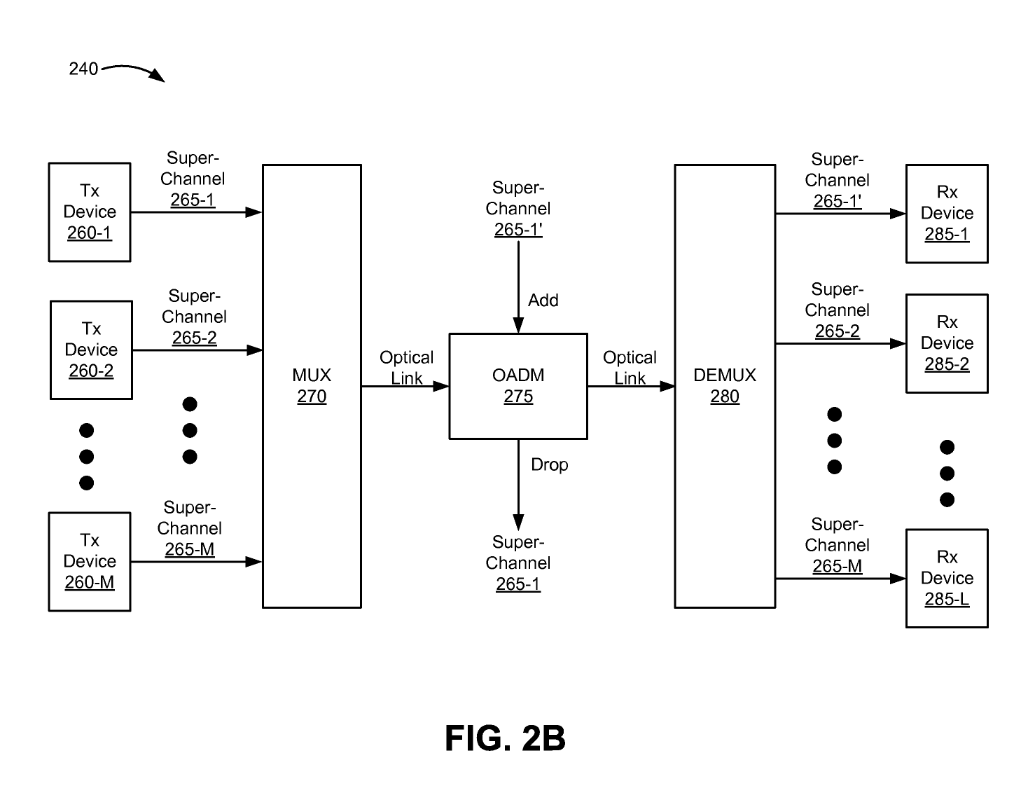

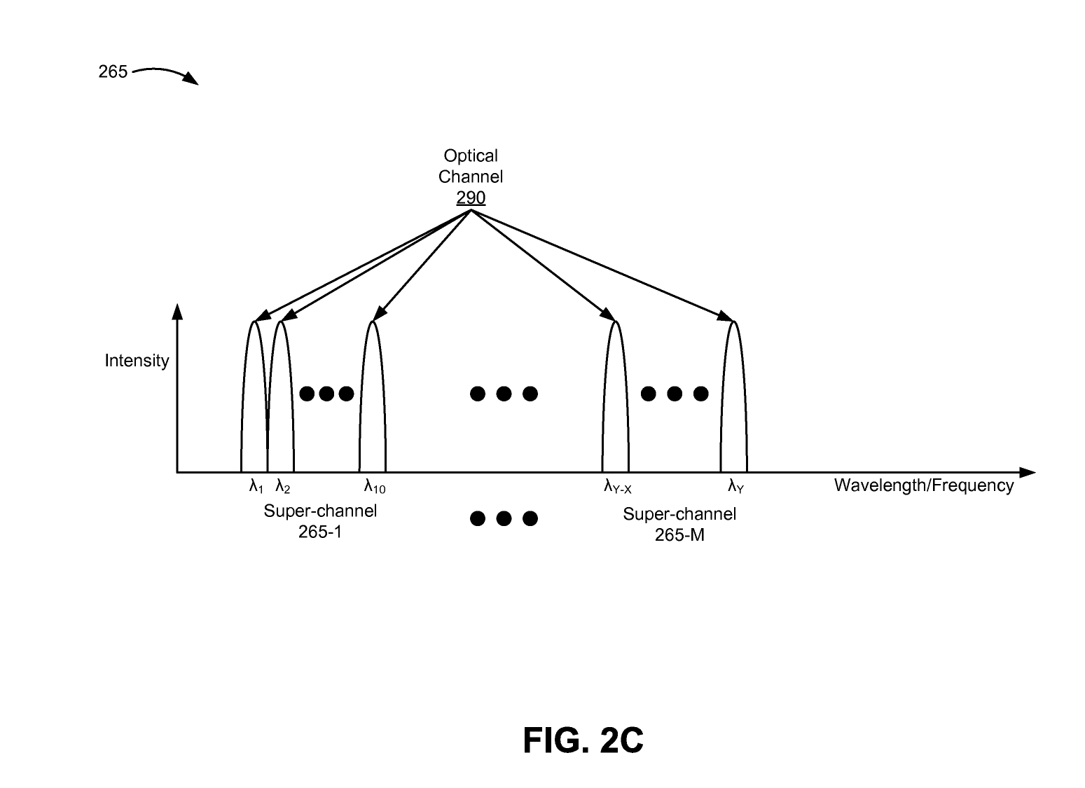

FIG. 2A is a diagram of an example environment 200 in which systems and/or methods, described herein, may be implemented. As shown in FIG. 2A, environment 200 may include a network planning system 210, a network administrator device 220, a user device 230, and an optical network 240, which may include a set of optical devices 250-1 through 250-N (N≧1) (hereinafter referred to individually as “optical device 250,” and collectively as “optical devices 250”). Devices of environment 200 may interconnect via wired connections, wireless connections, or a combination of wired and wireless connections.

Network planning system 210 may include one or more devices capable of receiving, generating, storing, processing, and/or providing optical network information. For example, network planning system 210 may include a computing device, such as a server or a similar type of device. Network planning system 210 may assist a user in modeling and/or planning an optical network, such as optical network 240. For example, network planning system 210 may assist in modeling and/or planning an optical network configuration, which may include quantities, locations, capacities, parameters, and/or configurations of optical devices 250, characteristics and/or configurations (e.g., capacities) of optical links between optical devices 250, traffic demands of optical devices 250 and/or optical links between optical devices 250, and/or any other network information associated with optical network 240 (e.g., optical device configurations, digital device configurations, etc.). Network planning system 210 may provide optical network information, associated with optical network 240, to network administrator device 220 so that a user may view, modify, and/or interact with the optical network information.

Network administrator device 220 may include one or more devices capable of receiving, generating, storing, processing, and/or providing optical network information. For example, network administrator device 220 may include a computing device, such as a server, a desktop computer, a laptop computer, or the like. In some implementations, network administrator device 220 may receive optical network information (e.g., from one or more devices shown in FIG. 2A), and may provide the optical network information for display via a user interface. Additionally, or alternatively, network administrator device 220 may provide the optical network information to another device, such as user device 230, for display via a user interface. In some implementations, network administrator device 220 may receive (e.g., from user device 230) information associated with a modification to optical network 240, and may provide information associated with the modification to optical network 240 and/or optical devices 250 to configure optical network 240 based on the modification.

User device 230 may include one or more devices capable of receiving, generating, storing, processing, and/or providing optical network information. For example, user device 230 may include a computing device, such as a desktop computer, a laptop computer, a tablet computer, a mobile phone (e.g., a smart phone, a radiotelephone, etc.), a handheld computer, or the like. In some implementations, user device 230 may receive optical network information from and/or transmit information to another device in environment 200. User device 230 may provide the optical network information for display via different sections of a user interface, and may provide an input mechanism for a user to navigate between different levels of optical network information provided via the different sections. In some implementations, user device 230 may receive user input to modify optical network information, and may provide the modified optical network information to an optical device 250 (e.g., via network administrator device 220) to cause the modification to be implemented in optical network 240.

Optical network 240 may include any type of network that uses light as a transmission medium. For example, optical network 240 may include a fiber-optic based network, an optical transport network, a light-emitting diode network, a laser diode network, an infrared network, and/or a combination of these or other types of optical networks. Optical network 240 may include one or more optical routes (e.g., optical lightpaths), that may specify a route along which light is carried (e.g., using one or more optical links) between two or more optical devices 250. An optical link may include an optical fiber, an optical control channel, an optical data channel, or the like, and may carry an optical channel (e.g., a signal associated with a particular wavelength of light), an optical super-channel, a super-channel group, an optical carrier group, a set of spectral slices, or the like.

In some implementations, an optical link may carry a set of spectral slices. A spectral slice (a “slice”) may represent a spectrum of a particular size in a frequency band (e.g., 12.5 gigahertz (“GHz”), 6.25 GHz, etc.). For example, a 4.8 terahertz (“THz”) frequency band may include 384 spectral slices, where each spectral slice may represent 12.5 GHz of the 4.8 THz spectrum. A super-channel may include a different quantity of spectral slices depending on the super-channel type.

Optical device 250 may include one or more devices capable of receiving, generating, storing, processing, and/or providing data, carried by an optical signal, via an optical link. For example, optical device 250 may include one or more optical data processing and/or optical traffic transfer devices, such as an optical amplifier (e.g., a doped fiber amplifier, an erbium doped fiber amplifier, a Raman amplifier, etc.), an optical add-drop multiplexer (“OADM”) (e.g., a reconfigurable optical add-drop multiplexer (“ROADM”), a flexibly reconfigurable optical add-drop multiplexer (“FROADM”), a fixed optical add-drop multiplexer (“FOADM”), etc.), an optical source device (e.g., a laser source), an optical destination device (e.g., a laser sink), an optical multiplexer, an optical demultiplexer, an optical transmitter, an optical receiver, an optical transceiver, a photonic integrated circuit, an integrated optical circuit, or the like. In some implementations, optical device 250 may include one or more optical components. Optical device 250 may process and/or transmit an optical signal (e.g., to another optical device 250 via an optical link) to deliver the optical signal through optical network 240.

The number and arrangement of devices and networks shown in FIG. 2A are provided as an example. In practice, there may be additional devices and/or networks, fewer devices and/or networks, different devices and/or networks, or differently arranged devices and/or networks than those shown in FIG. 2A. Furthermore, two or more devices shown in FIG. 2A may be implemented within a single device, or a single device shown in FIG. 2A may be implemented as multiple, distributed devices. Additionally, or alternatively, a set of devices (e.g., one or more devices) of environment 200 may perform one or more functions described as being performed by another set of devices of environment 200.

FIG. 2B is a diagram of example devices of optical network 240 that may be monitored and/or configured according to implementations described herein. One or more devices shown in FIG. 2B may operate within optical network 240, and may correspond to one or more optical devices 250 and/or one or more optical components of an optical device 250. As shown, optical network 240 may include a set of optical transmitter devices 260-1 through 260-M (M≧1) (hereinafter referred to individually as “Tx device 260,” and collectively as “Tx devices 260”), a set of super-channels 265-1 through 265-M (M≧1) (hereinafter referred to individually as “super-channel 265,” and collectively as “super-channels 265”), a multiplexer (“MUX”) 270, an OADM 275, a demultiplexer (“DEMUX”) 280, and one or more optical receiver devices 285-1 through 285-L (L≧1) (hereinafter referred to individually as “Rx device 285,” and collectively as “Rx devices 285”).

Tx device 260 may include, for example, an optical transmitter and/or an optical transceiver that generates an optical signal. For example, Tx device 260 may include one or more integrated circuits, such as a transmitter photonic integrated circuit (PIC), an application specific integrated circuit (ASIC), or the like. In some implementations, Tx device 260 may include a laser associated with each wavelength, a digital signal processor to process digital signals, a digital-to-analog converter to convert the digital signals to analog signals, a modulator to modulate the output of the laser, and/or a multiplexer to combine each of the modulated outputs (e.g., to form a combined output or WDM signal). One or more optical signals may be carried via super-channel 265. In some implementations, a single Tx device 260 may be associated with a single super-channel 265. In some implementations, a single Tx device 260 may be associated with multiple super-channels 265, or multiple Tx devices 260 may be associated with a single super-channel 265.

Super-channel 265 may include multiple channels multiplexed together using wavelength-division multiplexing to increase transmission capacity. Various quantities of channels may be combined into super-channels using various modulation formats to create different super-channel types having different characteristics. Additionally, or alternatively, an optical link may include a super-channel group. A super-channel group may include multiple super-channels multiplexed together using wavelength-division multiplexing to increase transmission capacity. Super-channel 265 is described in more detail herein in connection with FIG. 2C.

Multiplexer 270 may include, for example, an optical multiplexer (e.g., an arrayed waveguide grating) that combines multiple input super-channels 265 for transmission over an output fiber. For example, multiplexer 270 may combine super-channels 265-1 through 265-M, and may provide the combined super-channels 265 to OADM 275 via an optical link (e.g., a fiber).

OADM 275 may include, for example, a ROADM, a FROADM, a FOADM, or the like. OADM 275 may multiplex, de-multiplex, add, drop, and/or route multiple super-channels 265 into and/or out of a fiber (e.g., a single mode fiber). As illustrated, OADM 275 may drop super-channel 265-1 from a fiber, and may allow super-channels 265-2 through 265-M to continue propagating toward Rx device 285. Dropped super-channel 265-1 may be provided to a device (not shown) that may demodulate and/or otherwise process super-channel 265-1 to output the data stream carried by super-channel 265-1. As illustrated, super-channel 265-1 may be provisioned for transmission from Tx device 260-1 to OADM 275, where super-channel 265-1 may be dropped. As further shown, OADM 275 may add super-channel 265-1′ to the fiber. Super-channel 265-1′ may include one or more optical channels at the same or substantially the same wavelengths as super-channel 265-1. Super-channel 265-1′ and super-channels 265-2 through 265-M may propagate to demultiplexer 280.

Demultiplexer 280 may include, for example, an optical de-multiplexer (e.g., an arrayed waveguide grating) that separates multiple super-channels 265 carried over an input fiber. For example, demultiplexer 280 may separate super-channels 265-1′ and super-channels 265-2 through 265-M, and may provide each super-channel 265 to a corresponding Rx device 285.

Rx device 285 may include, for example, an optical receiver and/or an optical transceiver that receives an optical signal. For example, Rx device 285 may include one or more integrated circuits, such as a receiver PIC, an ASIC, or the like. In some implementations, Rx device 285 may include a demultiplexer to receive combined output and demultiplex the combined output into individual optical signals, a photodetector to convert an optical signal to a voltage signal, an analog-to-digital converter to convert voltage signals to digital signals, and/or a digital signal processor to process the digital signals. One or more optical signals may be received by Rx device 285 via super-channel 265. Rx device 285 may convert a super-channel 265 into one or more electrical signals, which may be processed to output information associated with each data stream carried by an optical channel included in super-channel 265. In some implementations, a single Rx device 285 may be associated with a single super-channel 265. In some implementations, a single Rx device 285 may be associated with multiple super-channels 265, or multiple Rx devices 285 may be associated with a single super-channel 265.

One or more devices shown in FIG. 2B may be an optical device 250. In some implementations, a combination of devices shown in FIG. 2B may be an optical device 250. For example, Tx devices 260-1 through 260-M and multiplexer 270 may be an optical device 250. As another example, Rx devices 285-1 through 285-L and demultiplexer 280 may be an optical device 250.

The number and arrangement of devices shown in FIG. 2B are provided as an example. In practice, there may be additional devices, fewer devices, different devices, or differently arranged devices, included in optical network 240, than those shown in FIG. 2B. Furthermore, two or more devices shown in FIG. 2B may be implemented within a single device, or a single device shown in FIG. 2B may be implemented as multiple, distributed devices. Additionally, or alternatively, a set of devices shown in FIG. 2B may perform one or more functions described as being performed by another set of devices shown in FIG. 2B.

FIG. 2C is a diagram of example super-channels 265 that may be monitored and/or configured according to implementations described herein. A super-channel may refer to multiple optical channels that are simultaneously transported over the same optical waveguide (e.g., a single mode optical fiber). Each optical channel included in a super-channel may be associated with a particular optical wavelength (or set of optical wavelengths). The multiple optical channels may be combined to create a super-channel using wavelength division multiplexing. For example, the multiple optical channels may be combined using dense wavelength division multiplexing, in which channel-to-channel spacing may be less than 1 nanometer. In some implementations, each optical channel may be modulated to carry an optical signal.

FIG. 2C shows an example frequency and/or wavelength spectrum associated with super-channels 265. In some implementations, the frequency and/or wavelength spectrum may be associated with a particular optical spectrum (e.g., C Band, C+Band, CDC Band, etc.). As shown, super-channel 265-1 may include multiple optical channels 290, each of which corresponds to a wavelength λ (e.g., λ₁, λ₂, through λ₁₀) within a first wavelength band. Similarly, super-channel 265-M may include multiple optical channels 290, each of which corresponds to a wavelength λ (e.g., λ_{Y-X} through λ_{Y}) within a second wavelength band. The quantity of depicted optical channels 290 per super-channel 265 is provided as an example. In practice, super-channel 265 may include any quantity of optical channels 290.

Optical channel 290 may be associated with a particular frequency and/or wavelength of light. In some implementations, optical channel 290 may be associated with a frequency and/or wavelength at which the intensity of light carried by optical channel 290 is strongest (e.g., a peak intensity, illustrated by the peaks on each optical channel 290). In some implementations, optical channel 290 may be associated with a set of frequencies and/or a set of wavelengths centered at a central frequency and/or wavelength. The intensity of light at the frequencies and/or wavelengths around the central frequency and/or wavelength may be weaker than the intensity of light at the central frequency and/or wavelength, as illustrated.

In some implementations, the spacing between adjacent wavelengths (e.g., λ₁ and λ₂) may be equal to or substantially equal to a bandwidth (or bit rate) associated with a data stream carried by optical channel 290. For example, assume each optical channel 290 included in super-channel 265-1 (e.g., λ₁ through λ₁₀) is associated with a 50 Gigabit per second (“Gbps”) data stream. In this example, super-channel 265-1 may have a collective data rate of 500 Gbps (e.g., 50 Gbps×10). In some implementations, the collective data rate of super-channel 265 may be greater than or equal to 100 Gbps. Additionally, or alternatively, the spacing between adjacent wavelengths may be non-uniform, and may vary within a particular super-channel band (e.g., super-channel 265-1). In some implementations, optical channels 290 included in super-channel 265 may be non-adjacent (e.g., may be associated with non-adjacent wavelengths in an optical spectrum).

Each super-channel 265 may be provisioned in optical network 240 as one optical channel and/or as an individual optical channel. Provisioning of an optical channel may include designating a route for the optical channel through optical network 240. For example, an optical channel may be provisioned to be transmitted via a set of optical devices 250. In some implementations, optical devices 250 may be configured as a ring. Additionally, or alternatively, optical devices 250 may be configured in a point-to-point configuration. Provisioning may be referred to as “allocating” and/or “allocation” herein. Even though each super-channel 265 is a composite of multiple optical channels 290, the optical channels 290 included in super-channel 265 may be routed together through optical network 240. Additionally, or alternatively, super-channel 265 may be managed and/or controlled in optical network 240 as though super-channel 265 included one optical channel at one wavelength.

The number and arrangement of super-channels and optical channels shown in FIG. 2C are provided as an example. In practice, there may be additional super-channels and/or optical channels, fewer super-channels and/or optical channels, different super-channels and/or optical channels, or differently arranged super-channels and/or optical channels than those shown in FIG. 2C.

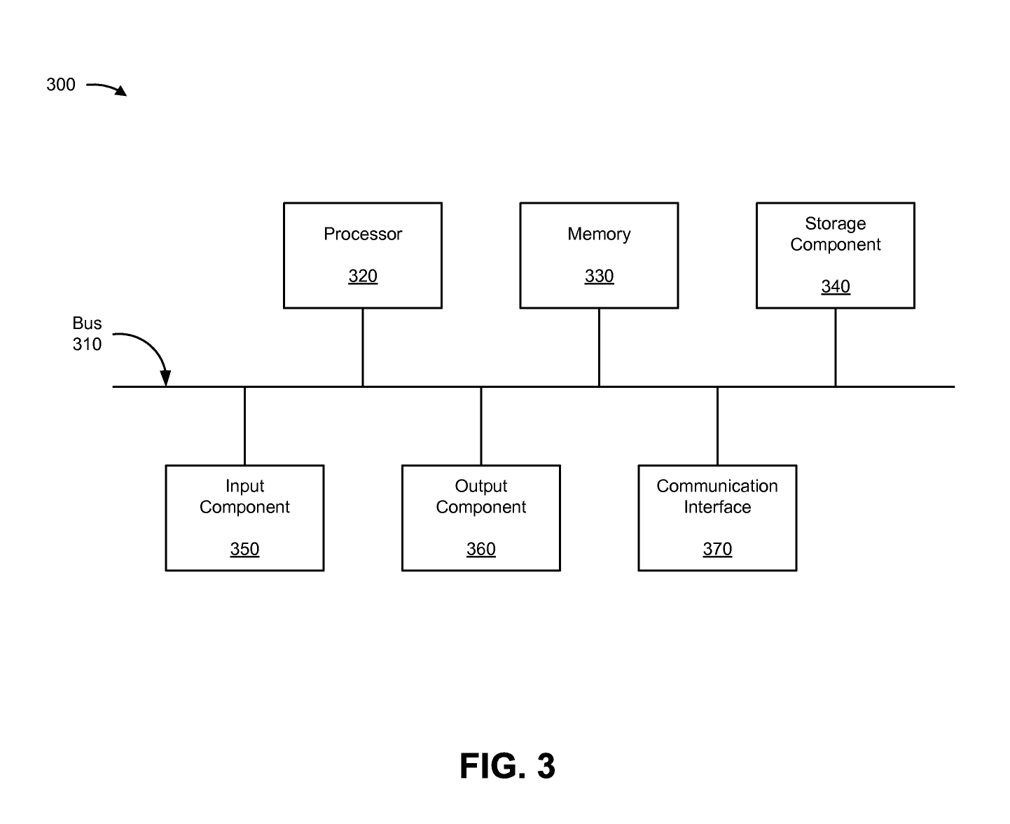

FIG. 3 is a diagram of example components of a device 300. Device 300 may correspond to network planning system 210, network administrator device 220, and/or user device 230. In some implementations, network planning system 210, network administrator device 220, and/or user device 230 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 may include a component that permits communication among the components of device 300. Processor 320 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. Memory 330 may include a random access memory (RAM), a read only memory (ROM), and/or another type of dynamic or static storage device (e.g., a flash memory, a magnetic memory, an optical memory, etc.) that stores information and/or instructions for use by processor 320.

Storage component 340 may store information and/or software related to the operation and use of device 300. For example, storage component 340 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 350 may include a component that permits device 300 to receive information, such as via user input (e.g., a touch screen display, a keyboard, a keypad, a mouse, a button, a switch, a microphone, etc.). Additionally, or alternatively, input component 350 may include a sensor for sensing information (e.g., a global positioning system (GPS) component, an accelerometer, a gyroscope, an actuator, etc.). Output component 360 may include a component that provides output information from device 300 (e.g., a display, a speaker, one or more light-emitting diodes (LEDs), etc.).

Communication interface 370 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

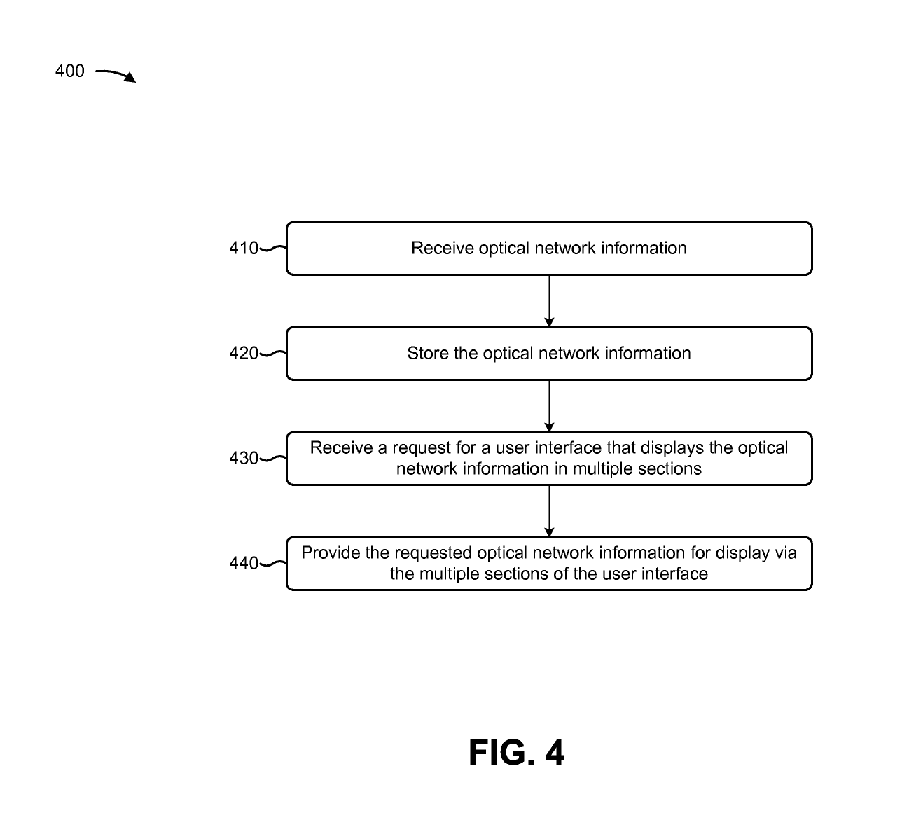

FIG. 4 is a flow chart of an example process 400 for receiving and storing optical network information, and providing the optical network information via a user interface. In some implementations, one or more process blocks of FIG. 4 may be performed by user device 230. In some implementations, one or more process blocks of FIG. 4 may be performed by another device or a group of devices separate from or including user device 230, such as network planning system 210, network administrator device 220, and/or optical device 250.

As shown in FIG. 4, process 400 may include receiving optical network information (block 410). For example, user device 230 may receive optical network information (e.g., from network planning system 210, network administrator device 220, optical device 250, etc.). In some implementations, user device 230 may request and/or receive the optical network information on a periodic basis (e.g., every second, every minute, every hour, every day, every week, etc.). Additionally, or alternatively, user device 230 may request and/or receive the optical network information based on input received from a user (e.g., a user request for the optical network information). Additionally, or alternatively, network planning system 210, network administrator device 220, and/or optical device 250 may automatically provide the optical network information to user device 230 (e.g., on a periodic basis, based on occurrence of an event, when the optical network information is modified, etc.).

Optical network information may include information associated with optical network 240, such as information associated with one or more optical devices 250, one or more optical components included in one or more optical devices 250, one or more optical super-channels carried by one or more optical components, one or more optical channels included in one or more optical superchannels, one or more optical links between optical devices 250, or the like.

As further shown in FIG. 4, process 400 may include storing the optical network information (block 420). For example, user device 230 may store the optical network information in a memory accessible by user device 230. In some implementations, user device 230 may store the information in a data structure.

As further shown in FIG. 4, process 400 may include receiving a request for a user interface that displays the optical network information in multiple sections (block 430). For example, user device 230 may receive a request (e.g., based on user input) for a user interface that displays optical network information associated with optical network 240. In some implementations, the optical network information may relate to a particular optical route (e.g., a set of optical devices 250 and/or optical links on the optical route). For example, a user may provide input that identifies an optical route (e.g., using a button, a drop-down menu or box, a link, a text box, etc.).

As further shown in FIG. 4, process 400 may include providing the requested optical network information for display via the multiple sections of the user interface (block 440). For example, user device 230 may provide the requested optical network information for display via a user interface. In some implementations, the user interface may be divided into different sections (e.g., windows, tabs, frames, areas, etc.), and each section may provide information associated with a different layer of optical network 240.

Optical network layers may be arranged in a hierarchy, and may include, in descending hierarchical order, an optical route layer (e.g., that includes information regarding a route with multiple optical devices 250 and links between the optical devices 250), an optical device layer (e.g., that includes information regarding optical device 250), an optical component layer (e.g., that includes information regarding an optical component that may be included in optical device 250), an optical super-channel layer (e.g., that includes information regarding an optical super-channel), an optical channel layer (e.g., that includes information regarding an optical channel included in an optical super-channel), or the like. In some implementations, different sections of the user interface may provide different optical network information (e.g., different levels of detail with more or less information, different types of information, etc.). In this way, a user may drill down to diagnose problems at different layers of an optical network.

As an example, the user interface may include a summary view that provides high-level summary information relating to one or more optical devices 250 and/or optical links included in an optical route. The summary information may include, for example, an optical device identifier, a representation of optical device 250, a capability associated with optical device 250, a status associated with optical device 250, a parameter associated with optical device 250, an error associated with optical device 250, an optical link associated with optical device 250, an optical link parameter associated with optical device 250, or the like. In this way, the user may easily navigate to an optical device that the user wishes to investigate before drilling down to discover detailed information associated with an optical component included in an optical device.

As another example, the user interface may include a detailed view that provides low-level detailed information relating to optical device(s) 250 and/or optical link(s). The detailed information may include, for example, an optical component identifier, a representation of an optical component, a capability associated with an optical component, a status associated with an optical component, a parameter associated with an optical component, an error associated with an optical component, or the like. In this way, the user may easily navigate to an optical component that the user wishes to investigate before drilling down to discover detailed information associated with a super-channel carried via the optical component.

As another example, the user interface may include a super-channel view that provides super-channel information relating to one or more super-channels configured on optical device 250 and/or an optical link. The super-channel information may include, for example, a super-channel identifier, a super-channel type, a status associated with a super-channel, a power characteristic associated with a super-channel, an error associated with a super-channel, or the like. In this way, the user may easily navigate to an optical super-channel that the user wishes to investigate before drilling down to discover detailed information associated with a channel included in the super-channel.

As another example, the user interface may include a channel view that provides channel information relating to one or more channels (e.g., a digital channel) included in a super-channel. The channel information may include, for example, a channel identifier, a status associated with a channel, an error associated with a channel, or the like. In this way, the user may easily navigate to an optical channel that the user wishes to investigate, and may view information associated with the optical channel (e.g., to diagnose problems).

In some implementations, user device 230 may provide an input mechanism that permits a user to provide input to customize the sections of the user interface. For example, the user may provide input to customize which sections are displayed, how many sections are displayed, a position where sections are displayed within the user interface, information provided by each section, or the like. User device 230 may customize the user interface and/or the user interface sections based on the input.

In this way, the user interface may provide optical network information such that a user may drill-down to obtain desired optical network information, such as to diagnose a problem associated with optical network 240. By providing different optical network information in different user interface sections as described herein, user device 230 may permit a user to drill-down into optical network information to more easily and efficiently monitor optical network 240 and/or diagnose optical network problems.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

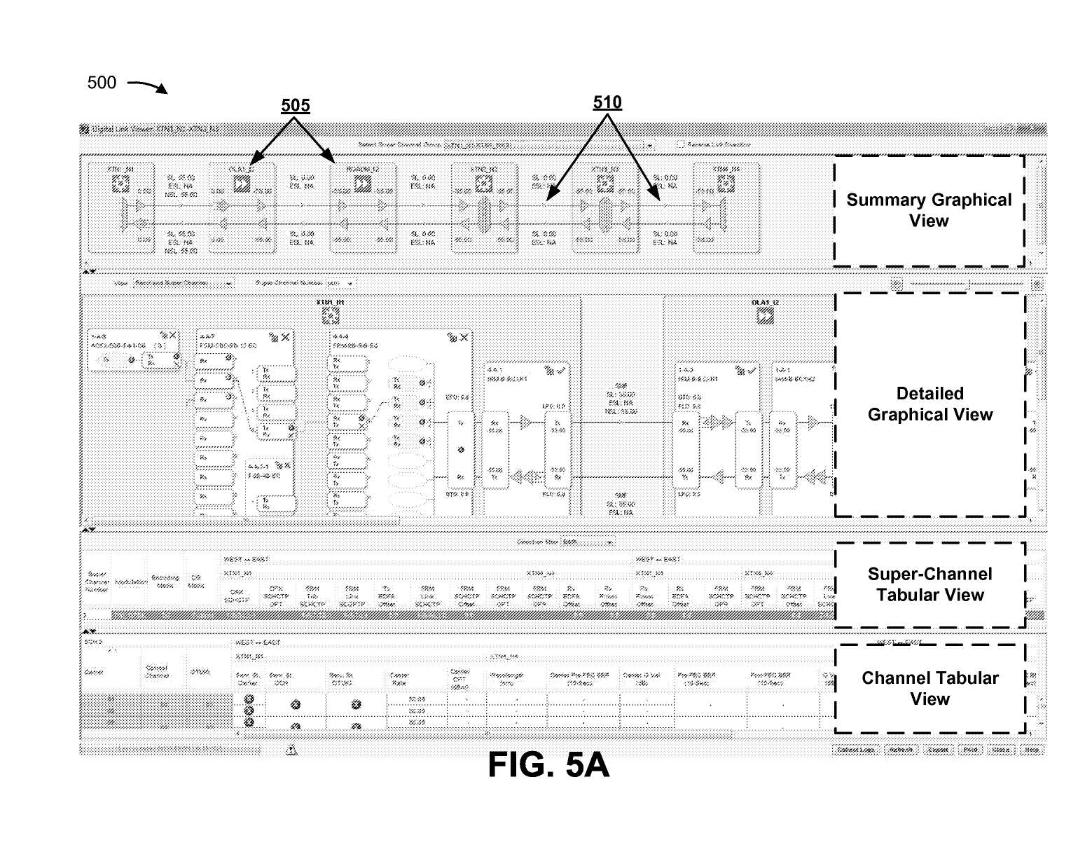

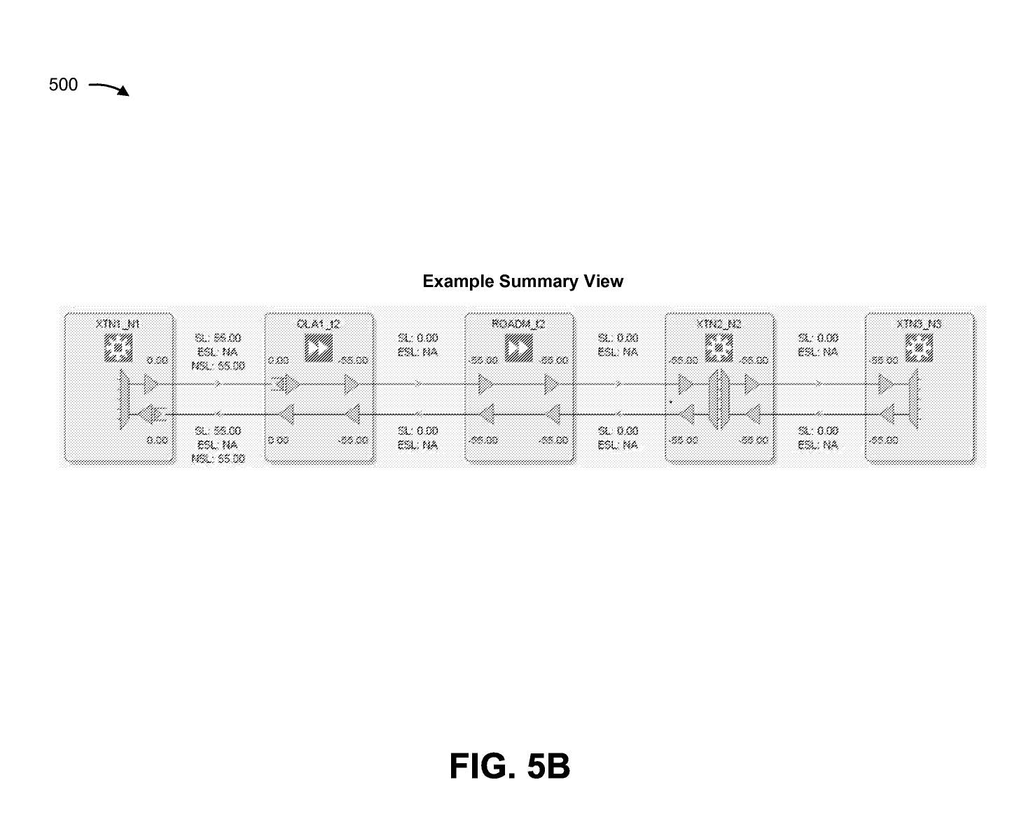

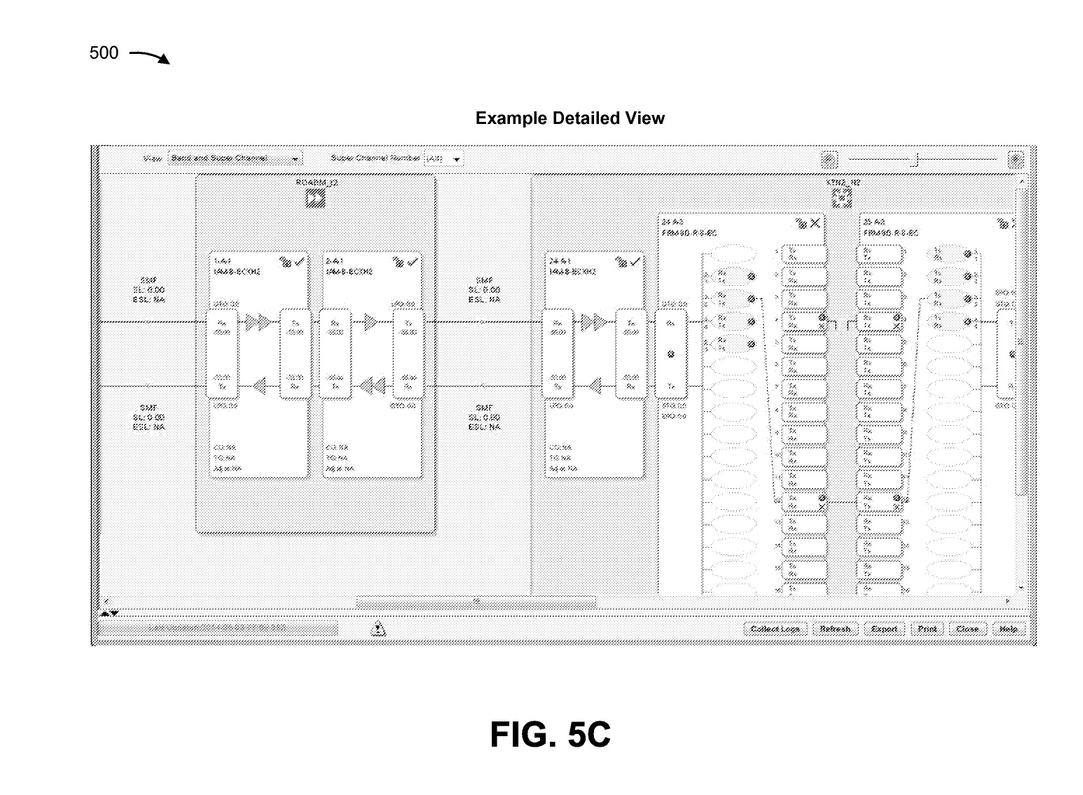

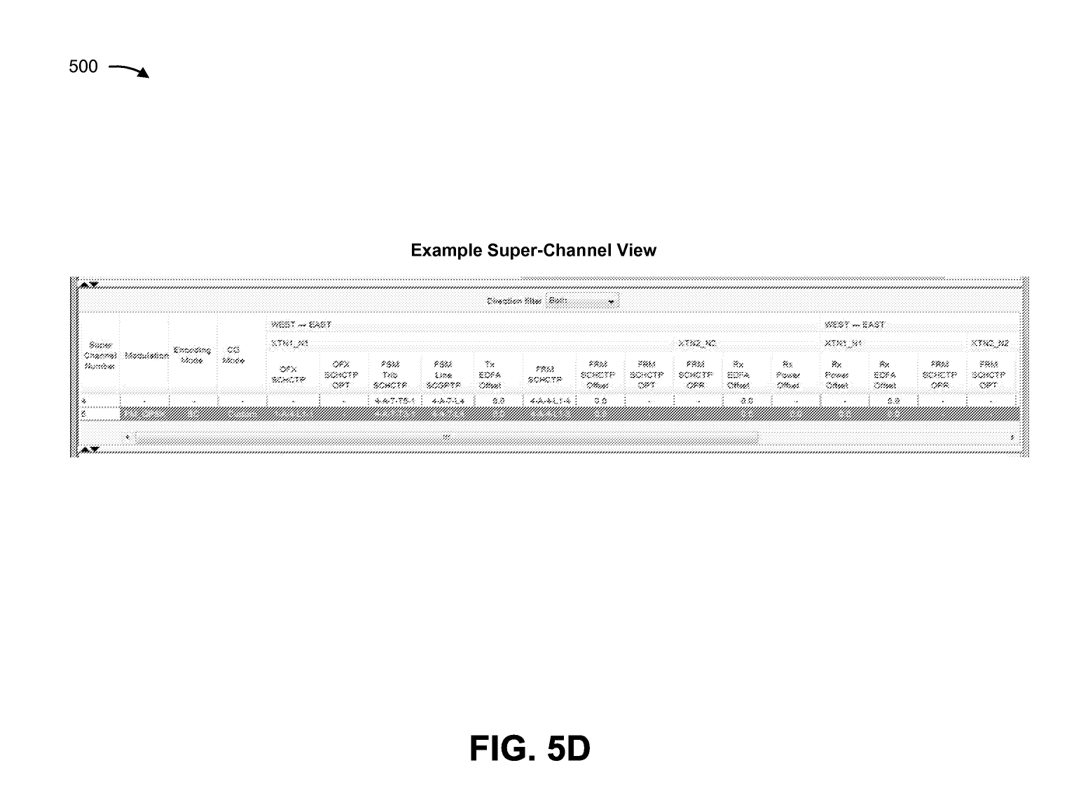

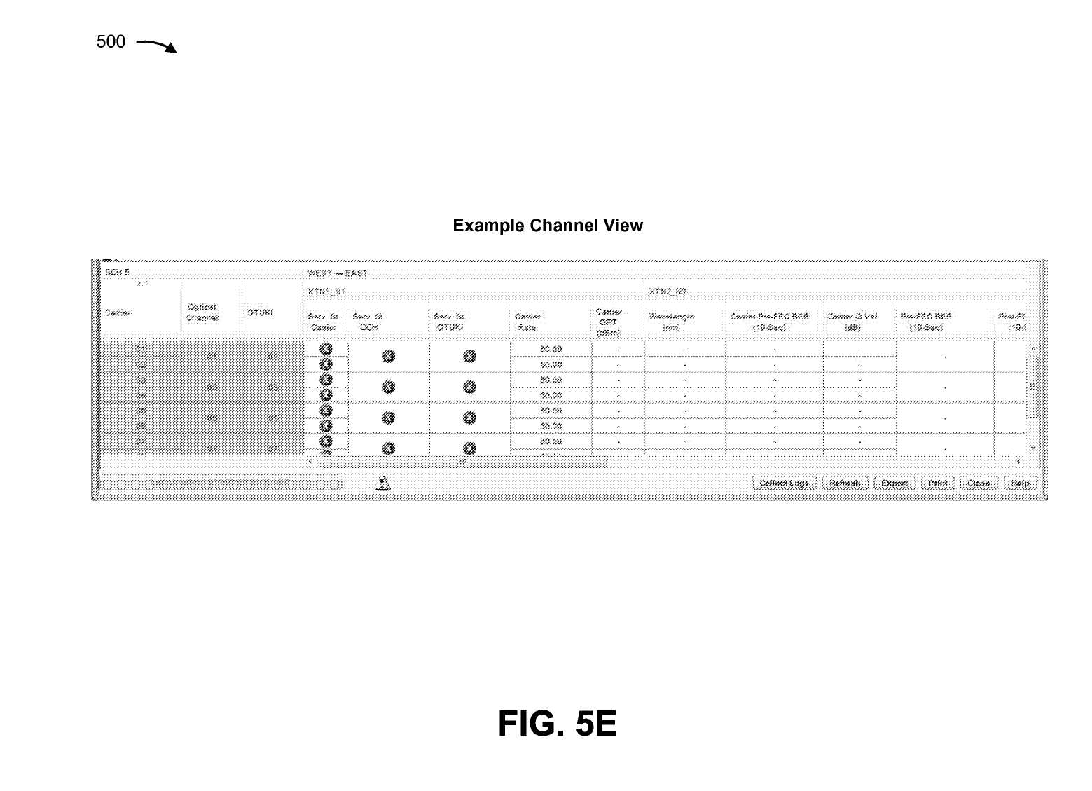

FIGS. 5A-5E are diagrams of an example implementation 500 relating to example process 400 shown in FIG. 4. FIGS. 5A-5E show example user interfaces for providing optical network information in different sections.

As shown in FIG. 5A, user device 230 may provide a user interface that provides optical network information associated with an optical route in optical network 240. The user interface may provide multiple sections, shown as a summary graphical view (e.g., a summary view), a detailed graphical view (e.g., a detailed view), a super-channel tabular view (e.g., a super-channel view), and a channel tabular view (e.g., a channel view).

The user interface may provide a representation of optical devices 250, as shown by reference number 505. Furthermore, the user interface may provide a representation of optical links between optical devices 250, as shown by reference number 510. In the example summary graphical view of example implementation 500, the user interface may provide optical device representations, optical link representations, optical device identifiers (e.g., “OLA1_t2”), an indication of an optical device type (e.g., an icon for an OADM, an icon for an amplifier, etc.), a summary representation of an optical component included in optical device 250 (e.g., a multiplexer, an amplifier, a type of amplifier, etc.), a span loss parameter of an optical link (e.g., an amount of power lost by an optical signal on an optical link between two optical devices 250), or the like. In this way, the user may view summary information associated with optical device 250, and may select optical device 250 to view more detailed information associated with optical device 250 (e.g., when the user interface indicates that there is a problem with optical device 250).

In the example detailed graphical view of example implementation 500, the user interface provides more detailed information relating to the optical devices 250 and optical links shown in the summary graphical view. For example, the example detailed graphical view may show an optical component identifier, a detailed representation of an optical component type (e.g., a version number, a model number, etc.), an operating mode associated with the optical component, a service state associated with the optical component, an administrative state associated with the optical component, a parameter associated with the optical component, adjustment information associated with the optical component, or the like. The detailed graphical view may provide more information than the summary graphical view regarding optical components, which are at a lower layer in an optical network hierarchy than optical devices 250 (e.g., at an optical component layer). In this way, the user may view detailed information associated with optical device 250 and/or an optical component, and may select super-channel, associated with optical device 250 or optical component to view information associated with the super-channel (e.g., when the user interface indicates that there is a problem with the super-channel).

In the example super-channel tabular view of example implementation 500, the user interface provides more detailed information relating to the super-channels carried by the optical components and optical devices 250 shown in the summary graphical view and the detailed graphical view. For example, the super-channel tabular view may show a super-channel identifier (e.g., an optical carrier group identifier), a modulation type associated with a super-channel, a service state associated with a super-channel, a parameter associated with a super-channel, a power characteristic associated with a super-channel, an encoding mode associated with a super-channel, a bandwidth associated with a super-channel, an error parameter associated with the super-channel, or the like. The super-channel tabular view may provide more information than the detailed graphical view regarding super-channels, which are at a lower layer in an optical network hierarchy than optical components. In this way, the user may view information associated with a super-channel, and may select a channel, included in the super-channel, to view more detailed information associated with the channel (e.g., when the user interface indicates that there is a problem with the channel).

In the example channel tabular view of example implementation 500, the user interface provides more detailed information relating to the channels included in the super-channels shown in the super-channel tabular view. For example, the channel tabular view may show a channel identifier, a modulation type associated with a channel, a service state associated with a channel, a parameter associated with a channel, a wavelength associated with a channel, a power characteristic associated with a channel, an encoding mode associated with a channel, an error parameter associated with the channel, or the like. The channel tabular view may provide more information than the super-channel tabular view regarding channels, which are at a lower layer in an optical network hierarchy than super-channels. In this way, the user may navigate to drill down to information associated with a channel (e.g., to diagnose a problem).

FIG. 5B shows an example summary view that may be provided on a first user interface section of user device 230. FIG. 5C shows an example detailed view that may be provided on a second user interface section of user device 230. FIG. 5D shows an example super-channel view that may be provided on a third user interface section of user device 230. FIG. 5E shows an example channel view that may be provided on a fourth user interface section of user device 230.

As indicated above, FIGS. 5A-5E are provided merely as examples. Other examples are possible and may differ from what was described with regard to FIGS. 5A-5E.

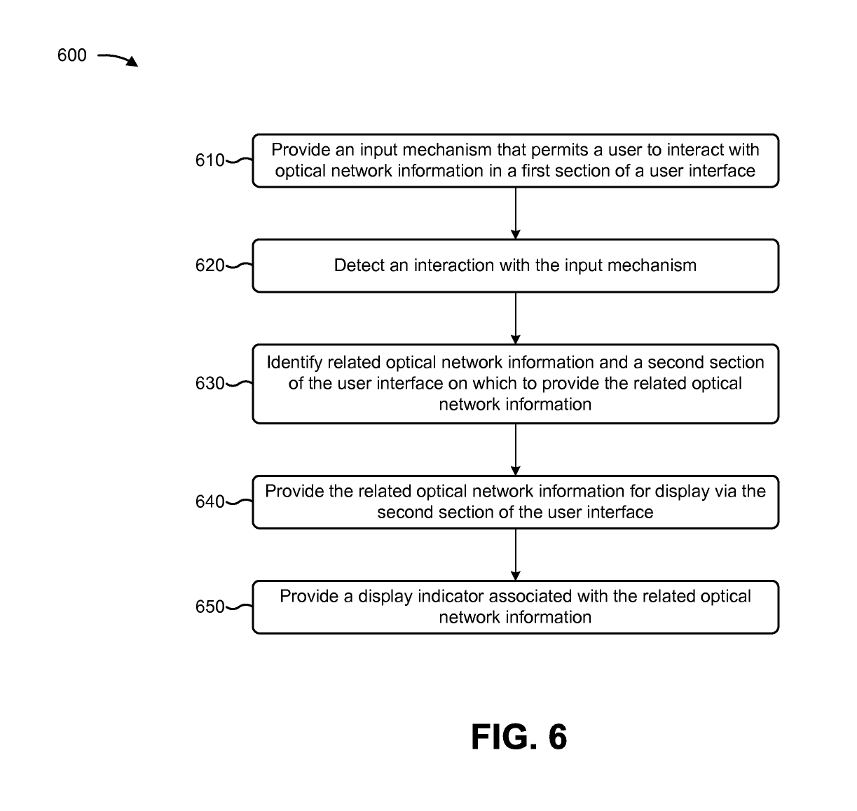

FIG. 6 is a flow chart of an example process 600 for providing user navigability of a user interface that displays optical network information. In some implementations, one or more process blocks of FIG. 6 may be performed by user device 230. In some implementations, one or more process blocks of FIG. 6 may be performed by another device or a group of devices separate from or including user device 230, such as network planning system 210, network administrator device 220, and/or optical device 250.

As shown in FIG. 6, process 600 may include providing an input mechanism that permits a user to interact with optical network information in a first section of a user interface (block 610). For example, user device 230 may provide an input mechanism that permits the user to interact with optical network information shown in a first section of a user interface. In some implementations, user device 230 may provide the input mechanism via the user interface, such as via a button, a link, a drop-down menu, a checkbox, interactive information, or the like. As an example, user device 230 may provide a representation of an optical device 250, and may provide an input mechanism that permits a user to click the representation.

As further shown in FIG. 6, process 600 may include detecting an interaction with the input mechanism (block 620), and identifying related optical network information and a second section of the user interface on which to provide the related optical network information (block 630). For example, user device 230 may detect a user interaction with first optical network information provided in a first section of the user interface. Based on the user interaction, user device 230 may identify second optical network information relating to the first optical network information.

The second optical network information may include, for example, different optical network information than the first optical network information, more detailed optical network information than the first optical network information (e.g., may include more information), optical network information relating to a different optical layer (e.g., a lower layer) of optical network 240, or the like. In some implementations, user device 230 may search information stored in a data structure to identify the second optical network information (e.g., based on a stored relationship indicator that indicates a relationship between the first optical network information and the second optical network information).

Additionally, or alternatively, user device 230 may identify a second section of the user interface, via which to provide the second optical network information, based on the user interaction. For example, user device 230 may search information stored in a data structure to identify the second section of the user interface. As an example, if the user interacts with a representation of optical device 250, provided in the summary view section, user device 230 may identify optical network information associated with an optical component of optical device 250. In this case, user device 230 may provide the identified optical network information for display in the detailed view section of the user interface, or may provide an indicator that identifies the identified optical network information in the detailed view section (e.g., when the identified optical network information is already provided for display in the detailed view section, user device 230 may highlight the information), as described in more detail below.

As further shown in FIG. 6, process 600 may include providing the related optical network information for display via the second section of the user interface (block 640), and providing a display indicator associated with the related optical network information (block 650). For example, user device 230 may provide the related optical network information for display in the second section of the user interface if the information is not already provided for display. In some implementations, user device 230 may scroll the second section so that the related optical network information is visible on the user interface.

Additionally, or alternatively, user device 230 may provide a display indicator that identifies the related optical network information in the second section. User device 230 may provide the display indicator in a manner that differentiates the related information from other information displayed via the second section of the user interface. For example, user device 230 may highlight the related information (e.g., using a particular color), may outline the related information, may center the related information in the user interface and/or in the second section of the user interface, or the like. In this way, user device 230 may assist the user in easily navigating the user interface.

As an example, if the user clicks on a first representation of an OADM provided in the summary view section, user device 230 may scroll to a second representation of that OADM in the detailed view section, and may highlight the second representation. The second representation may include optical network information associated with optical components of the OADM, such as a multiplexer, an amplifier, a summary representation of a super-channel, or the like.

As another example, if the user clicks on a representation of a super-channel provided in the detailed view section, user device 230 may provide optical network information relating to the super-channel via a table in a super-channel view section. The optical network information may identify one or more channels included in the super-channel. As another example, if the user clicks on a representation of a channel provided in the super-channel view section, user device 230 may provide optical network information relating to the channel via a table in a channel view section. Process 600 may be repeated to permit the user to drill down to lower layers of information (e.g., more detailed information) associated with optical network 240.

In this way, user device 230 may provide optical network information in an organized manner that is easy for a user to understand and navigate. This may assist the user in finding relevant information and/or diagnosing problems associated with optical network 240.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

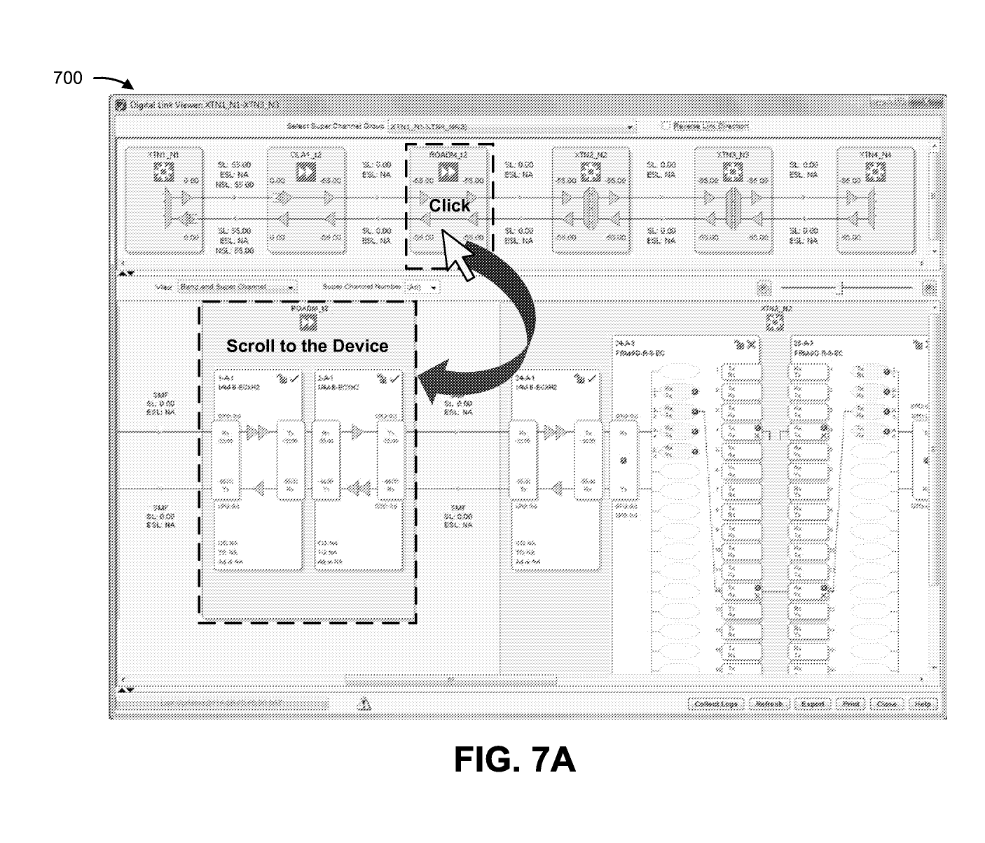

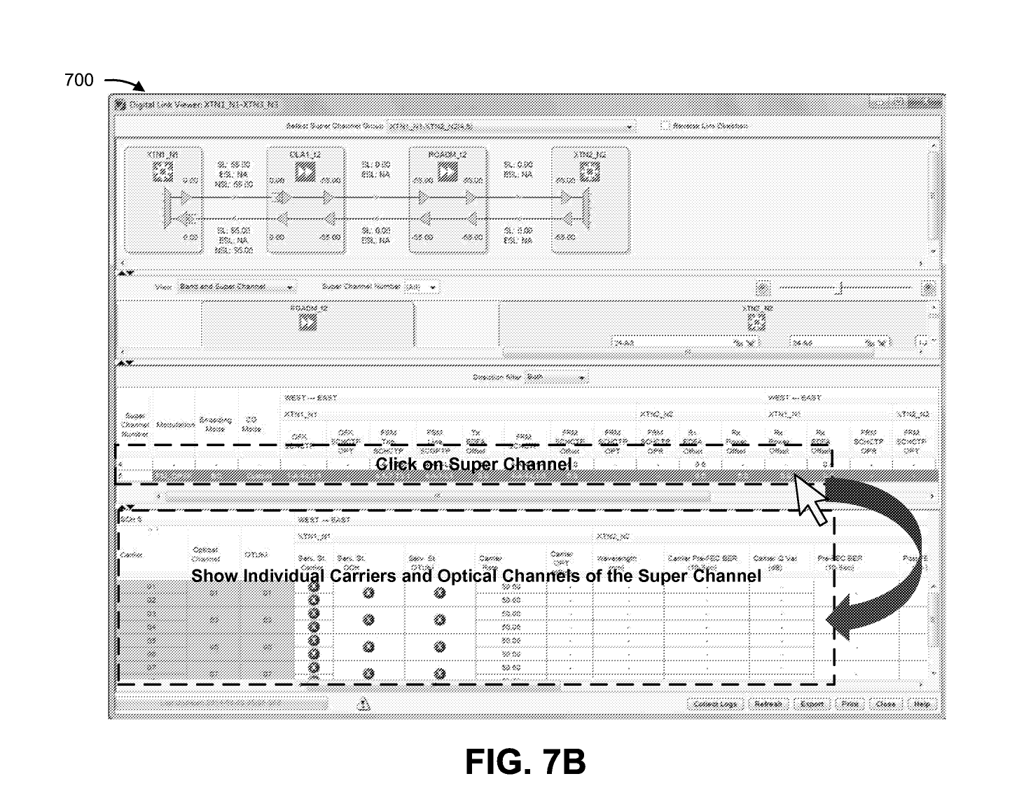

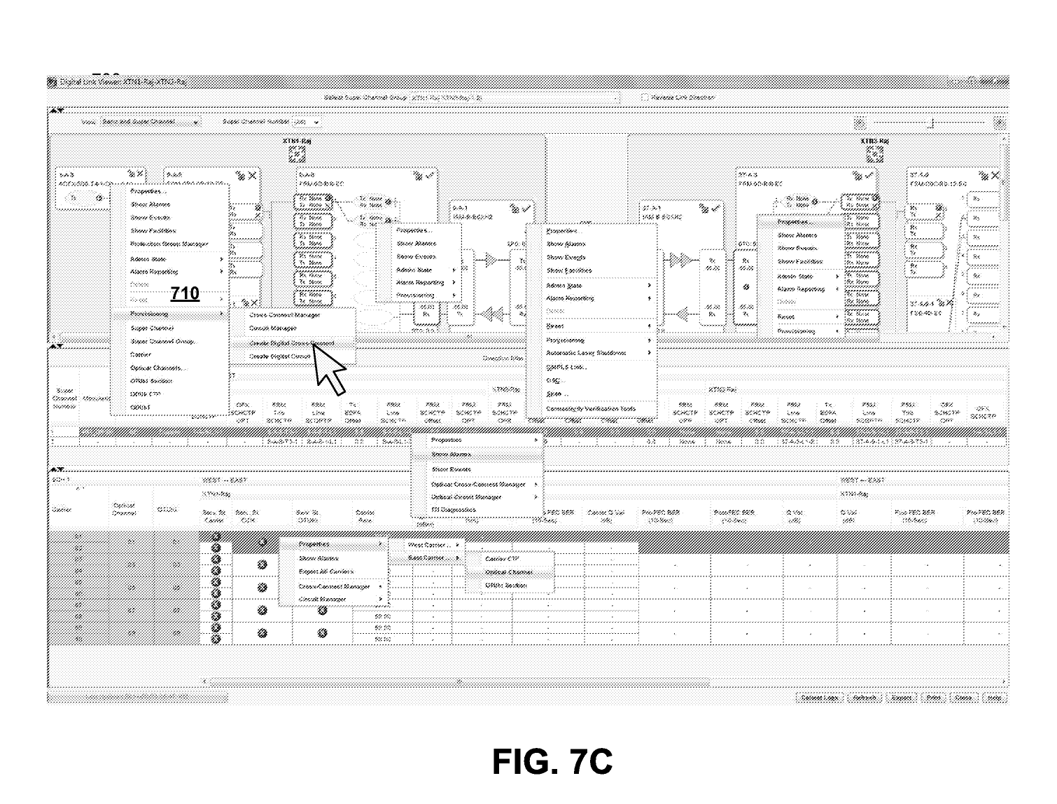

FIGS. 7A-7C are diagrams of an example implementation 700 relating to example process 600 shown in FIG. 6. FIGS. 7A-7C show example user interfaces for navigating different sections of a user interface to provide optical network information.

As shown in FIG. 7A, assume that the user clicks on a first representation of optical device 250, provided in the summary view section of the user interface, which represents an optical device identified as “ROADM_t2.” Based on detecting the click, user device 230 scrolls the detailed view section to a second representation of ROADM_t2, and outlines the second representation with a box. As shown, the detailed view section provides optical network information, associated with ROADM_t2, that is not provided in the summary view section. In this way, the user may navigate through different sections to discover additional information about optical network 240. Similarly, the user may interact with a representation of a super-channel, shown in the detailed view section, to provide optical network information, associated with the super-channel, in the super-channel view section of the user interface.

As shown in FIG. 7B, assume that the user selects a representation of a super-channel, provided in the super-channel view section, which represents a super-channel identified as “Super-channel 5.” Based on detecting the click, user device 230 shows, in the channel view section, optical network information relating to optical channels associated with the selected super-channel (e.g., wavelengths associated with a super-channel). In this way, the user may drill down through an optical network hierarchy to obtain information associated with a particular level of the optical network hierarchy in a structured manner.

As shown in FIG. 7C, the user may also interact with a representation of optical information to display a set of options for monitoring and/or configuring optical equipment. For example, the user may right-click on an OADM to provide a menu of options, as shown by reference number 710. As an example, the user may interact with a menu item to provision a cross-connect to carry a super-channel. As another example, the user may interact with a representation of an optical link, a termination point, or the like, to display optical network information associated with the represented equipment (e.g., optical device 250, an optical component, etc.), to monitor the represented equipment, to diagnose errors associated with the represented equipment, to modify the represented equipment, or the like. In some implementations, the user may provide input to modify optical device 250, and user device 230 may provide information associated with the modification to optical device 250 (e.g., via network administrator device 220). In this way, the user may configure optical device 250.

As indicated above, FIGS. 7A-7C are provided merely as an example. Other examples are possible and may differ from what was described with regard to FIGS. 7A-7C.

Implementations described herein provide a user interface with different sections for viewing different types of optical network information, depending on a type of optical network information that the user wishes to monitor. Furthermore, implementations described herein provide input mechanisms for the user to easily navigate between the different sections of the user interface, to help the user find relevant optical network information.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

Certain user interfaces have been described herein and/or shown in the figures. A user interface may include a graphical user interface, a non-graphical user interface, a text-based user interface, etc. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device, comprising:
one or more processors to:
receive optical network information associated with a plurality of optical devices included in an optical network,
the optical network information including first optical network information and second optical network information,
the second optical network information including at least some information that is different from the first optical network information,
the second optical network information relating to the first optical network information;
provide the first optical network information via a first section of a user interface;
detect an interaction with the first optical network information; and
provide, based on detecting the interaction, at least one of:
the second optical network information via a second section of the user interface that is different from the first section, or
a display indicator that identifies the second optical network information provided via the second section of the user interface.

2. The device of claim 1, where the first optical network information includes information associated with an optical device, of the plurality of optical devices, included in the optical network; and
where the second optical network information includes information associated with an optical component included in the optical device.

3. The device of claim 1, where the first optical network information includes information associated with an optical component included in an optical device of the plurality of optical devices; and
where the second optical network information includes information associated with an optical super-channel carried via the optical component.

4. The device of claim 1, where the first optical network information includes information associated with an optical super-channel carried via an optical component included in an optical device of the plurality of optical devices; and
where the second optical network information includes information associated with one or more channels included in the optical super-channel.

5. The device of claim 1, where the one or more processors are further to:
detect an interaction with the second optical network information; and
provide, based on detecting the interaction with the second optical network information, third optical network information via a third section of the user interface,
the third optical network information including at least some information that is different from the first optical network information and the second optical network information,
the third section being different from the first section and the second section.

6. The device of claim 5, where the first optical network information includes information associated with an optical device, of the plurality of optical devices, included in the optical network;
where the second optical network information includes information associated with an optical component included in the optical device; and
where the third optical network information includes information associated with an optical super-channel carried via the optical component.

7. The device of claim 5, where the first optical network information includes information associated with an optical component included in an optical device of the plurality of optical devices;
where the second optical network information includes information associated with an optical super-channel carried via the optical component; and
where the third optical network information includes information associated with one or more channels included in the optical super-channel.

8. A computer-readable medium storing instructions, the instructions comprising:
one or more instructions that, when executed by one or more processors, cause the one or more processors to:
receive optical network information associated with an optical network,
the optical network information including first optical network information and second optical network information,
the first optical network information including a first level of information,
the second optical network information including a second level of information,
the second level of information being lower and containing more details than the first level of information;
provide the first optical network information via a first section of a user interface;
detect an interaction with the first optical network information; and
provide, based on detecting the interaction, at least one of:
the second optical network information via a second section of the user interface that is different from the first section, or
a display indicator that visually distinguishes the second optical network information within the second section of the user interface.

9. The computer-readable medium of claim 8, where the one or more instructions, that cause the one or more processors to provide the second optical network information or the display indicator, further cause the one or more processors to:
provide the second optical network information by presenting the second optical network information within the second section of the user interface.

10. The computer-readable medium of claim 8, where the one or more instructions, that cause the one or more processors to provide the second optical network information or the display indicator, further cause the one or more processors to:
scroll within the second section of the user interface so that the second optical network information is visible within the second section of the user interface.

11. The computer-readable medium of claim 8, where the one or more instructions, that cause the one or more processors to provide the second optical network information or the display indicator, further cause the one or more processors to:
present the second optical network information in a different manner than other information provided via the second section of the user interface.

12. The computer-readable medium of claim 8, where the first optical network information relates to at least one of:
an optical device included in the optical network,
an optical component included in the optical device,
an optical super-channel transmitted or received by the optical component or the optical device,
an optical channel included in the optical super-channel, or
a digital channel included in the optical super-channel.

13. The computer-readable medium of claim 8, where the first optical network information includes information associated with an optical device included in the optical network; and
where the second optical network information includes information associated with an optical component included in the optical device.

14. The computer-readable medium of claim 8, where the first optical network information includes information associated with an optical super-channel carried via an optical component included in an optical device of the optical network; and
where the second optical network information includes information associated with one or more channels included in the optical super-channel.

15. A method, comprising:
receiving, by a device, optical network information associated with a plurality of optical devices included in an optical network,
the optical network information including first optical network information and second optical network information,
the second optical network information including information associated with a lower layer of the optical network than the first optical network information,
the second optical network information relating to the first optical network information;
providing, by the device, the first optical network information for display via a first section of a user interface;
detecting, by the device, an interaction associated with the first optical network information; and
providing, by the device and based on detecting the interaction, at least one of:
the second optical network information for display via a second section of the user interface that is different from the first section, or
a display indicator identifying the second optical network information provided for display via the second section of the user interface.

16. The method of claim 15, where the first section of the user interface includes information associated with an optical device, of the plurality of optical devices, included in the optical network; and
where the second section of the user interface includes information associated with an optical component included in the optical device.

17. The method of claim 15, where the first section of the user interface includes information associated with an optical component included in an optical device of the plurality of optical devices; and
where the second section of the user interface includes information associated with an optical super-channel carried via the optical component.

18. The method of claim 15, where the first section of the user interface includes information associated with an optical super-channel carried via an optical component included in an optical device of the plurality of optical devices; and
where the second section of the user interface includes information associated with one or more channels included in the optical super-channel.

19. The method of claim 15, further comprising:
detecting an interaction with the second optical network information;
providing, based on detecting the interaction with the second optical network information, third optical network information for display via a third section of the user interface,
the third optical network information including information associated with a lower layer of the optical network than the first optical network information and the second optical network information,
the third section being different from the first section and the second section;
detecting an interaction with the third optical network information;
providing, based on detecting the interaction with the third optical network information, fourth optical network information for display via a fourth section of the user interface,
the fourth optical network information including information associated with a lower layer of the optical network than the first optical network information, the second optical network information, and the third optical network information,
the fourth section being different from the first section, the second section, and the third section.

20. The method of claim 19, where the first optical network information includes information associated with an optical device of the plurality of optical devices;
where the second optical network information includes information associated with an optical component included in the optical device;
where the third optical network information includes information associated with an optical super-channel carried via the optical component; and
where the fourth optical network information includes information associated with one or more channels included in the optical super-channel.
